(19) United States
(12) Patent Application Publication
(10) Pub. No.: US 2019/0193636 A1
(43) Pub. Date: Jun. 27, 2019

(54) VEHICLE VISUAL RECOGNITION DEVICE

(71) Applicant: KABUSHIKI KAISHA TOKAI-RIKA-DENKI-SEISAKUSHO, Aichi (JP)

(72) Inventor: Kazuhiro SAWADA, Aichi (JP)

(21) Appl. No.: 16/327,415

(22) PCT Filed: Sep. 1, 2017
(86) PCT No.: PCT/JP2017/031650

§ 371 Date: Feb. 22, 2019

(30) Foreign Application Priority Data
Sep. 8, 2016 (JP) 2016-175543

(51) Int. Cl. B60R 1/076; F16J 15/3204

(52) U.S. Cl. CPC B60R 1/076; F16J 15/3204

(57) ABSTRACT

A vehicle door mirror device is provided that includes a stay that is provided at a vehicle exterior, and a mirror main body that is supported by the stay, and that is provided with a mirror to facilitate visual recognition by an occupant. A seal member is provided between a base of the stay and the mirror main body, and a seal section is provided at the seal member that is elastically deformable so as to effect sealing between the base of the stay and the mirror main body. The seal section is provided with a hollow portion at an extension portion extending from a base end side of the seal section. This enables the seal section to undergo elastic deformation readily, enabling resistance to rotation of the mirror main body to be reduced.

### TECHNICAL FIELD

The present invention relates to a vehicle visual recognition device in which a visual recognition means facilitate visual recognition by an occupant of a vehicle.

### BACKGROUND ART

In a door mirror described in Japanese Patent Application Laid-Open (JP-A) No. H11-180216, a base member is fixed to a vehicle body, a mirror housing is supported by the base member, and the mirror housing is capable of rotating with respect to the base member. A wind noise prevention member is provided between the base member and the mirror housing. A ring shaped wall portion of the wind noise prevention member seals between the base member and the mirror housing.

However, in this door mirror, there is a possibility that resistance to the rotation of the mirror housing might be increased by the ring shaped wall portion.

### SUMMARY OF INVENTION

### Technical Problem

In consideration of the above circumstances, an object of the present invention is to provide a vehicle visual recognition device capable of reducing resistance to the rotation of a main body.

### Solution to Problem

A vehicle visual recognition device of a first aspect of the present invention includes a support section that is provided at a vehicle exterior section, a main body that is supported by the support section, and that is provided with a visual recognition means to facilitate visual recognition by an occupant, a seal member that is provided between the support section and the main body, and a seal section that is provided at the seal member, that is elastically deformable, that seals between the support section and the main body, and that is provided with a hollow portion.

In the vehicle visual recognition device of the first aspect, the main body is rotatably supported by the support section, and the main body is provided with the visual recognition means. The seal member is provided between the support section and the main body, and the seal section of the seal member seals between the support section and the main body.

Note that the seal section is provided with the hollow portion. This enables the seal section to undergo elastic deformation readily, enabling resistance to the rotation of the main body to be reduced.

A vehicle visual recognition device of a second aspect is the first aspect, further including a restriction section configured to restrict movement of the seal section in the radial direction relative to a direction of rotation of the main body.

The vehicle visual recognition device of the second aspect is provided with the restriction section, and the restriction section restricts movement of the seal section in the radial direction. This enables misalignment of the seal section in the radial direction to be suppressed.

### Advantageous Effects of Invention

The vehicle visual recognition device of the first aspect has an advantageous effect of enabling resistance to the rotation of the main body to be reduced.

The vehicle visual recognition device of the second aspect has an advantageous effect of enabling misalignment of the seal section in the radial direction to be suppressed.

### BRIEF DESCRIPTION OF DRAWINGS

FIG. 1 is a plan view illustrating a door mirror device according to a first exemplary embodiment, as viewed from above.

FIG. 2 is a cross-section illustrating a door mirror device as viewed from a vehicle width direction inside.

FIG. 3 is an enlarged cross-section illustrating relevant portions of the door mirror device illustrated in FIG. 2.

FIG. 4A is a perspective view illustrating relevant portions of a stay.

FIG. 4B is a cross-section of a seal member, taken along line 4B-4B in FIG. 4A.

FIG. 5 is an enlarged cross-section corresponding to FIG. 3, illustrating relevant portions of a door mirror device according to a second exemplary embodiment.

### DESCRIPTION OF EMBODIMENTS

Detailed explanation follows regarding exemplary embodiments of the present invention, with reference to the drawings.

### First Exemplary Embodiment

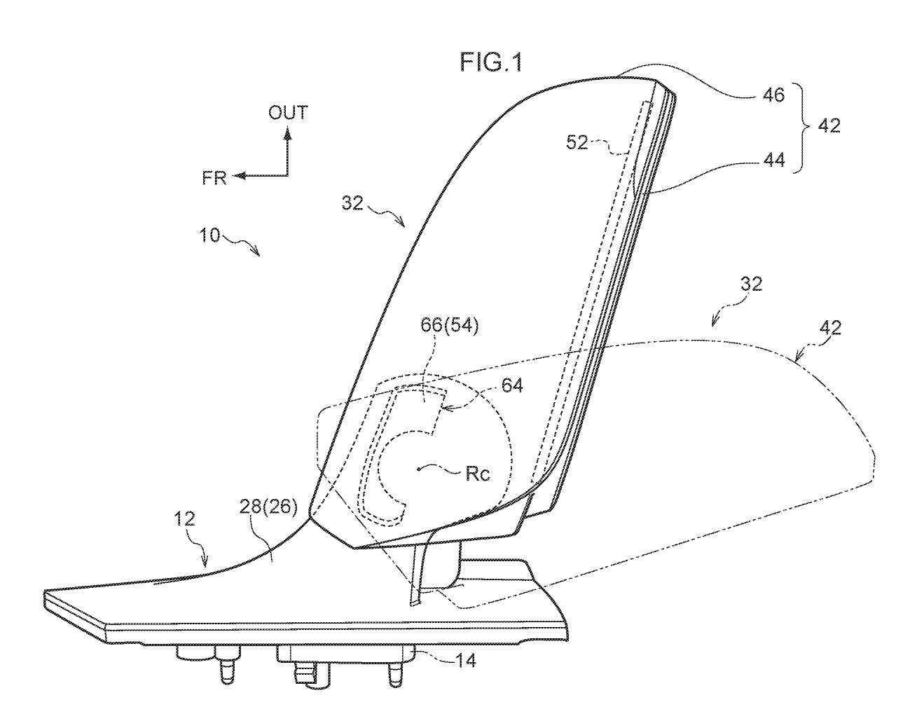

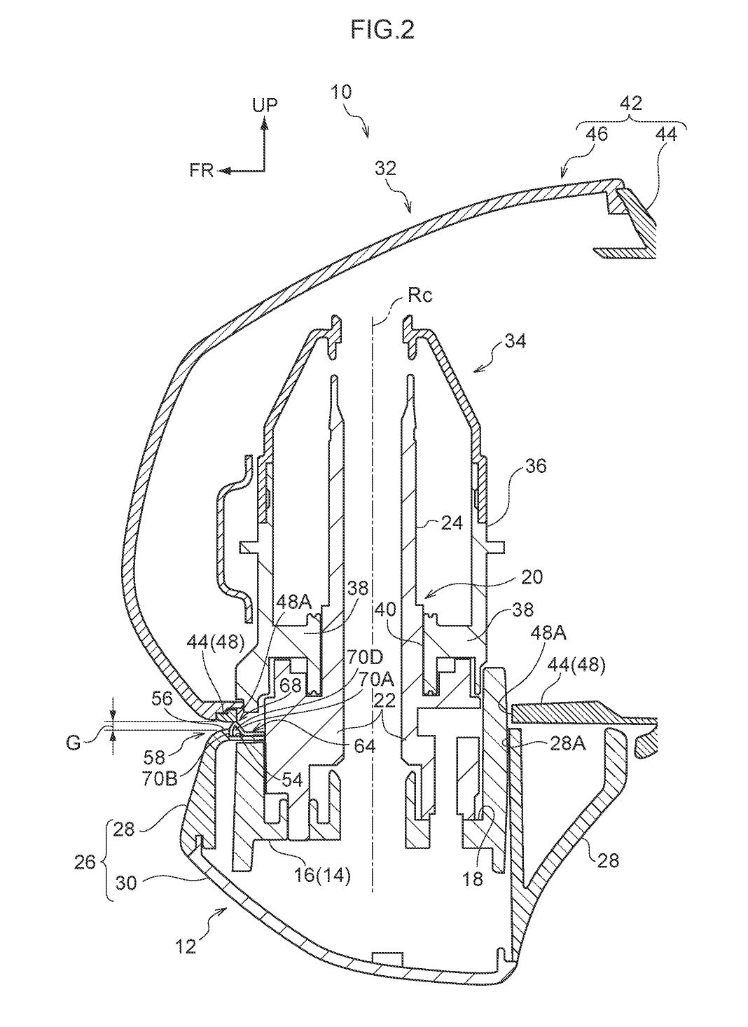

FIG. 1 is a plan view illustrating a door mirror device 10, serving as a vehicle visual recognition device according to a first exemplary embodiment, as viewed from above. FIG. 2 is a cross-section illustrating the door mirror device 10 as viewed from a vehicle width direction inside. Note that in each of the drawings, the arrow FR indicates the vehicle front, the arrow OUT indicates the vehicle width direction outside (vehicle right), and the arrow UP indicates upward.

The door mirror device 10 is provided to an exterior section at an up-down direction intermediate section of a vehicle front side end of a vehicle front door (not illustrated in the drawings). As illustrated in FIG. 1 and FIG. 2, a stay 12, serving as a support section, is provided at the door mirror device 10. A base 14, serving as a support member, is provided to the stay 12. The vehicle width direction inside of the base 14 is attached to and supported by the vehicle front door. A substantially circular cylinder shaped stand housing section 16 is provided at a vehicle width direction outside end portion of the base 14. A recessed portion 18 that opens upward is formed in the stand housing section 16.

A substantially circular cylinder shaped stand 20 is supported by the stand housing section 16. A substantially circular cylinder shaped stand-side base portion 22 is provided at a lower portion of the stand 20. A substantially circular cylinder shaped support shaft 24 projects upward from a central portion of the stand-side base portion 22. The stand-side base portion 22 is housed in the recessed portion 18 of the stand housing section 16 inside a through-hole 28A of an upper base cover 28, described below, and is fixed to the stand housing section 16 (base 14). The axial center of the support shaft 24 is parallel to the up-down direction.

A base cover 26, serving as a first covering member, is provided to the stay 12. As illustrated in FIG. 2, the base cover 26 includes the upper base cover 28 and a lower base cover 30, each of which has a curved plate shaped profile. The upper base cover 28 is formed in a recessed shape that opens downward, and is fixed to the base 14 so as to cover the base 14 from above. The lower base cover 30 is formed in a recessed shape that opens upward, and is attached to the lower side of the upper base cover 28. The base 14 of the stay 12 is thereby covered by the base cover 26.

The through-hole 28A is formed so as to penetrate the upper base cover 28 in the up-down direction. An upper end portion of the stand housing section 16 and the stand-side base portion 22 are disposed in a state inserted inside the through-hole 28A.

As illustrated in FIG. 2, a mirror main body 32, serving as a main body, is provided to the door mirror device 10. A stowing unit 34 is provided to the mirror main body 32, and a case 36, configured as a substantially tube shaped box body, is provided to the stowing unit 34.

A bottom portion of the case 36 configures a case-side base portion 38. A support hole 40 is formed so as to penetrate the case-side base portion 38 in the up-down direction. The case-side base portion 38 opposes the stand-side base portion 22, and the support shaft 24 of the stand 20 is inserted through the support hole 40. The case 36 is thereby supported by the base 14 through the stand 20, and is capable of rotating with respect to the base 14 about a rotation center Rc at the axial center of the support shaft 24. A drive mechanism (not illustrated in the drawings) is provided to the case 36. When the drive mechanism is driven, the case 36 rotates with respect to the base 14 about the rotation center Rc at the support shaft 24 of the stand 20.

A visor 42, serving as a second covering member, is provided to the mirror main body 32. The visor 42 includes a visor body 44 and a visor cover 46. The visor body 44 is disposed at the vehicle rear side of the stowing unit 34, and the visor cover 46 is disposed at the vehicle front side of the visor body 44.

A substantially flat plate shaped bottom wall 48 is provided at a vehicle width direction inside lower end portion of the visor body 44. The bottom wall 48 opposes a substantially planar upper face at the vehicle width direction outside of the stay 12. A through-hole 48A is formed penetrating the bottom wall 48 in the up-down direction. The stand-side base portion 22 of the stand 20 is disposed in a state inserted through the through-hole 48A.

As illustrated in FIG. 1, the case 36 is fixed to a vehicle width direction inside portion of the visor body 44 at the vehicle front side, such that the visor body 44 is supported by the case 36. The visor cover 46 has a curved plate shaped profile that forms a recessed profile opening toward the vehicle rear (visor body 44).

As illustrated in FIG. 2, the visor cover 46 is assembled to the vehicle front side of the visor body 44 of the visor 42. The stowing unit 34 is thereby housed inside the visor 42, and the mirror main body 32 is rotatably supported by the stay 12 (the base 14 and the support shaft 24) through the stowing unit 34.

The mirror main body 32 is disposed in an unfolded position (the position illustrated by solid lines in FIG. 1; a deployed position) when the mirror main body 32 is at a position projecting toward the vehicle width direction outside. The mirror main body 32 is disposed in a stowed position (the position illustrated by a double-dotted dashed line in FIG. 1; a rear folded position) by rotating the mirror main body 32 toward the vehicle width direction inside and the vehicle rear side.

A housing section (not illustrated in the drawings) that is open toward the vehicle rear side is provided to the visor body 44. A mirror body 52 (see FIG. 1), serving as a visual recognition means, is housed inside the housing section. The mirror body 52 is disposed such that a reflective face (mirror face) is directed toward the vehicle rear side when the mirror main body 32 is in the unfolded position.

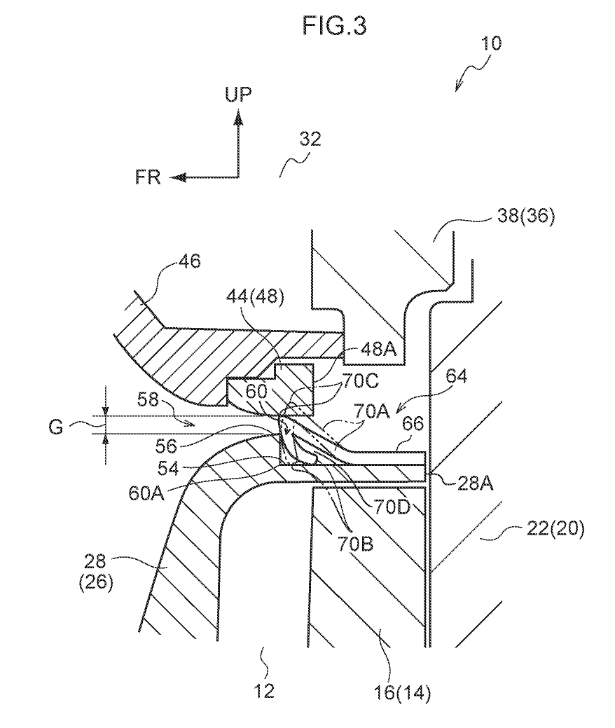

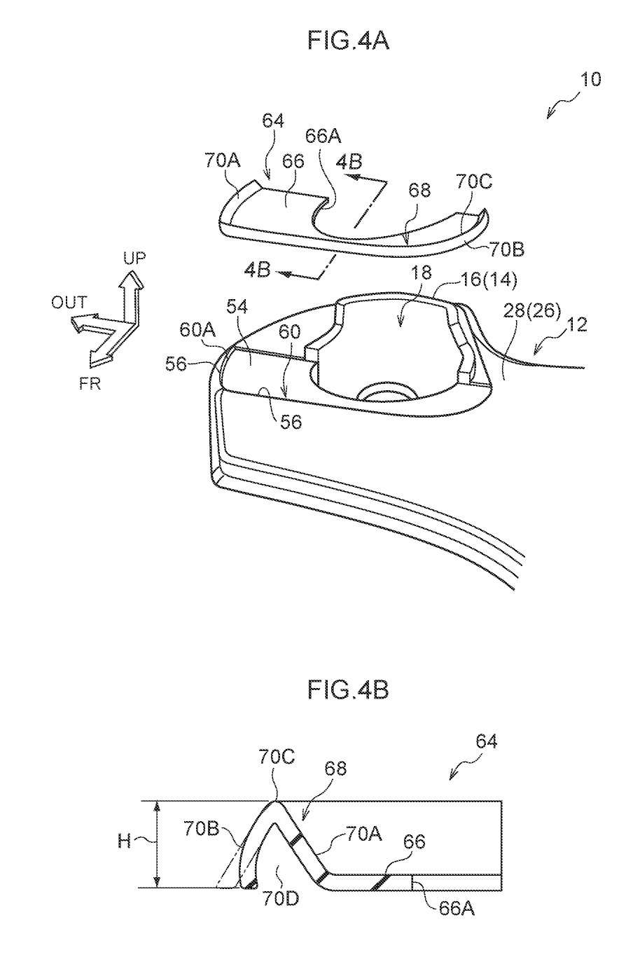

FIG. 3 is a cross-section illustrating vehicle front side portions of the upper base cover 28 and the visor body 44, as viewed from the vehicle width direction inside. FIG. 4A is a perspective view illustrating relevant portions of the stay 12 as viewed from the vehicle front side and vehicle width direction inside. FIG. 4B is a cross-section taken along line 4B-4B in FIG. 4A.

As illustrated in FIG. 3 and FIG. 4A, a planar opposing face 54 is formed to an upper face of the upper base cover 28 and the stand housing section 16, at the periphery of the recessed portion 18. The opposing face 54 opposes the bottom wall 48 of the visor body 44 at the vehicle front side of an opening center of the recessed portion 18, and is formed substantially parallel to the bottom wall 48 (lower face) of the visor body 44 (see FIG. 2 also). The opposing face 54 is formed in substantially a U shape in plan view, and opposes the visor body 44 in the up-down direction over a rotation range of the mirror main body 32 between the unfolded position and the stowed position (see FIG. 1 and FIG. 4A).

As illustrated in FIG. 3 and FIG. 4A, a projection portion 56 is provided to the upper base cover 28. The projection portion 56 is formed at the vehicle front side and at both vehicle width direction sides of the opposing face 54. As illustrated in FIG. 4A, the projection portion 56 is formed so as to surround the opposing face 54 from the vehicle front side and both vehicle width direction sides of the opposing face 54. The projection portion 56 projects from the upper base cover 28 toward the bottom wall 48 of the visor body 44.

Thus, as illustrated in FIG. 3, a narrow separation 58 at the projection portion 56, where the upper base cover 28 and the visor body 44 (bottom wall 48) are separated from each other across a gap G, is formed between the upper base cover 28 and the visor body 44 (bottom wall 48). In the door mirror device 10, a standard value (nominal value, design value) is set for the gap G at the separation 58, and tolerance of the gap G with respect to the standard value is set to a predetermined dimensional range. Providing the door mirror device 10 with the gap G suppresses interference between the upper base cover 28 and the visor body 44 as the mirror main body 32 rotates.

A step section 60 is formed to the upper base cover 28. The step section 60 is formed between the opposing face 54 and the projection portion 56, and an upright wall 60A, serving as a regulating section, is formed at an end face on the opposing face 54 side of the projection portion 56.

A seal member 64 is disposed between the upper base cover 28 and the visor body 44. A sheet shaped base section 66 and a seal section 68 are provided to the seal member 64. The base section 66 and the seal section 68 are integrally molded from an elastomer, serving as an elastic member. Note that the seal member 64 is not limited to being configured from an elastomer, this being a synthetic rubber, and various types of elastic member (elastic material), such as natural rubber, may be applied.

The base section 66 is formed in a substantially U shape corresponding to the shape of the opposing face 54 of the upper base cover 28 and the stand housing section 16, and a semicircular shaped cutout 66A is formed at a position corresponding to the recessed portion 18 (see FIG. 1 and FIG. 4A). The cutout 66A has a slightly larger diameter than the stand-side base portion 22 disposed inside the recessed portion 18.

As illustrated in FIG. 4B, the seal section 68 is formed of a sloped wall 70A, serving as a first portion extending from an outer peripheral end of the base section 66 toward the visor body 44, and a sloped wall 70B, serving as a second portion extending from an upper end of the sloped wall 70B toward the opposing face 54. The seal section 68 is thereby formed in a substantially peaked shape, and a portion coupling the sloped wall 70A and the sloped wall 70B together configures an apex portion 70C. The apex portion 70C protrudes toward the visor body 44. Due to forming the seal section 68 in a substantially peaked shape, a hollow portion 70D is formed between the sloped walls 70A, 70B. The hollow portion 70D is open toward the opposite side to the apex portion 70C (toward the lower side, the opposing face 54-side).

A leading end portion (lower end portion) of the sloped wall 70B of the seal section 68 is curved toward the base section 66 side. The sloped wall 70B thereby curls inward with a profile projecting toward the opposite side to the sloped wall 70A in the seal section 68. Note that a state in which the sloped wall 70B is not curved is illustrated by double-dotted dashed lines in FIG. 4B.

In the seal section 68, the sloped wall 70B contacts the upright wall 60A. The lower end portion of the sloped wall 70B contacts an end portion on the upright wall 60A side of the opposing face 54, and the apex portion 70C contacts the visor body 44. An up-down direction dimension H of the seal section 68 (see FIG. 4B) is set so as to be greater than the distance between the opposing face 54 and the bottom wall 48 (a lower face of the bottom wall 48) of the visor body 44 when the gap G at the separation 58 is the largest permitted by the tolerance range. The seal section 68 forms a seal between the upper base cover 28 and the visor body 44 inside the separation 58.

Explanation follows regarding operation of the first exemplary embodiment.

In the door mirror device 10 with the above configuration, when the drive mechanism of the stowing unit 34 is driven or an external force is input to the mirror main body 32, the mirror main body 32 is rotated with respect to the stay 12. The mirror main body 32 is thereby disposed in a position between the unfolded position and the deployed position.

Note that the seal member 64 is provided at the opposing face 54 of the upper base cover 28 and the stand housing section 16, and that the seal section 68 of the seal member 64 is disposed between the upper base cover 28 and the visor body 44 toward the inside (the rotation center Rc side) of the separation 58.

When the apex portion 70C contacts the visor body 44 (bottom wall 48), the sloped walls 70A, 70B of the seal section 68 undergo elastic deformation. As a result, the sloped wall 70B contacts the upright wall 60A of the step section 60 and the seal section 68 seals between the upper base cover 28 and the visor body 44 inside the separation 58.

This enables a traveling airflow that arises accompanying vehicle travel to be suppressed from blowing through the separation 58 to the inside of the separation 58, thereby enabling wind noise to be suppressed. Moreover, the inside of the separation 58 is blocked from view by the seal section 68, thereby enabling the external appearance of the door mirror device 10 to be improved.

The hollow portion 70D is provided inside the seal section 68, and the sloped wall 70A and the sloped wall 70B are separated from each other by the hollow portion 70D. This enables the seal section 68 to undergo elastic deformation readily, and enables an urging force to be reduced in comparison to cases in which the hollow portion 70D is filled in and the seal section 68 is solid. This enables a reduction in frictional resistance between the visor body 44 and the apex portion 70C when the mirror main body 32 rotates, thereby enabling resistance to the rotation of the mirror main body 32 to be reduced. This enables the mirror main body 32 to rotate smoothly with respect to the stay 12, even when the seal section 68 has formed a seal between the upper base cover 28 and the visor body 44.

Furthermore, the hollow portion 70D maintains the seal section 68 in an elastically deformable state, thereby enabling the seal section 68 to be suppressed from increasing resistance to the rotation of the mirror main body 32, and enabling defective rotation operation of the mirror main body 32 to be prevented.

Moreover, the upright wall 60A is provided to the upper base cover 28. Movement of the sloped wall 70B in a direction away from the sloped wall 70A (base section 66) is restricted by the upright wall 60A, and the sloped wall 70B contacts the upright wall 60A in a state in which the sloped wall 70B is elastically deformed on the upright wall 60A side. This enables a suitable seal to be achieved between the upper base cover 28 and the visor body 44.

### Second Exemplary Embodiment

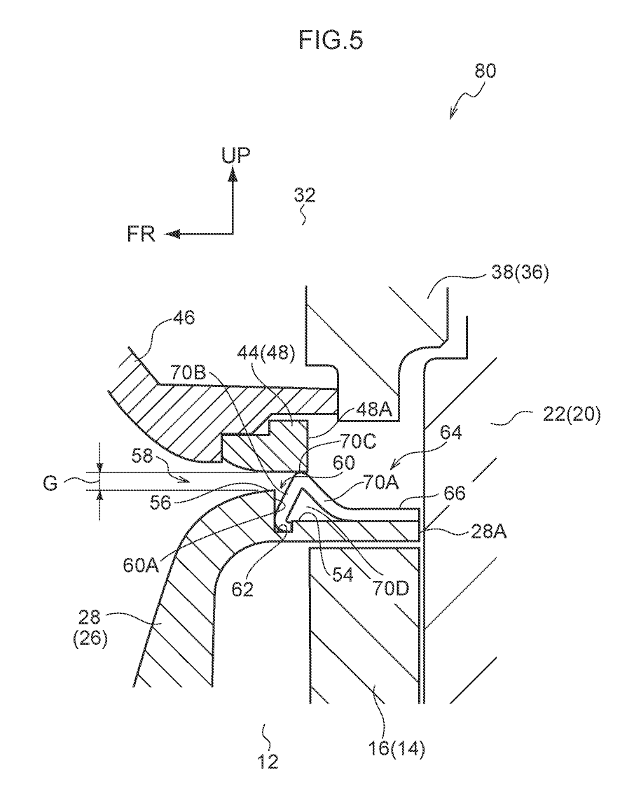

Explanation follows regarding a second exemplary embodiment. FIG. 5 is a cross-section illustrating relevant portions of a door mirror device 80, serving as a vehicle visual recognition device according to a second exemplary embodiment, as viewed from the vehicle width direction inside. The door mirror device 80 according to the second exemplary embodiment has basically the same configuration as the door mirror device 10 according to the first exemplary embodiment, but differs in the following respects.

In the door mirror device 80, a groove portion 62 with a substantially rectangular shaped cross-section profile and serving as a restriction section is formed to the opposing face 54 of the upper base cover 28. The groove portion 62 is provided on the opposing face 54 side of the upright wall 60A. An opening cross-section width of the groove portion 62 is wider than the thickness of the sloped wall 70B. The groove portion 62 extends along a lower end of the upright wall 60A.

The lower end portion of the sloped wall 70B is fitted into the groove portion 62. The sloped wall 70B is bent such that the lower end portion thereof extends in a direction away from the upright wall 60A inside the groove portion 62.

The door mirror device 80 configured as described above enables similar advantageous effects to the door mirror device 10 according to the first exemplary embodiment to be exhibited.

Moreover, the lower end portion of the sloped wall 70B of the seal section 68 is fitted into the groove portion 62 of the upper base cover 28. The lower end portion of the sloped wall 70B is thereby restricted from moving both in a direction away from the sloped wall 70A (base section 66) and in a direction approaching the sloped wall 70A. This enables the sloped wall 70B to suitably contact the upright wall 60A of the upper base cover 28.

In the first and second exemplary embodiments, the visor body 44 (or the bottom wall 48) preferably covers the entire upper side of the seal member 64 further toward the inside than the apex portion 70C in a rotation range of the mirror main body 32 from the unfolded position to the stowed position (preferably over the entirety of this rotation range).

In the first and second exemplary embodiments described above, the seal member 64 is provided at the upper base cover 28, and the apex portion 70C of the seal section 68 of the seal member 64 contacts the visor body 44. However, the seal member 64 may be provided at the visor body 44, such that the upper base cover 28 contacts the apex portion 70C of the seal section 68.

In the first and second exemplary embodiments, the projection portion 56 is provided at the upper base cover 28. However, there is no limitation thereto, and the projection portion 56 may be provided at the visor body 44 that opposes the upper base cover 28.

In the first and second exemplary embodiments, the seal section 68 is provided over a range spanning substantially half the periphery of the mirror main body 32 further toward the vehicle front side than the rotation center Rc. However, the range over which the seal section 68 is provided is not limited thereto. The seal section 68 may be provided around the entire periphery of the rotation center Rc of the mirror main body 32.

In the first exemplary embodiment, the upright wall 60A is provided as a restriction section, and in the second exemplary embodiment, the groove portion 62 is provided as a restriction section. However, as long as movement of the sloped wall 70B can be restricted, the restriction section is not limited to the groove portion 62, and a rib shaped protrusion may be provided.

Furthermore, in the first and second exemplary embodiments, the seal section 68 including the apex portion 70C and the hollow portion 70D formed by the sloped wall 70A and the sloped wall 70B is applied. However, the seal section is not limited thereto. A seal section 68 formed in a tube shape, such as triangular shape, may be formed as the seal section by extending the base section 66 of the seal member 64 as far as the lower end portion of the sloped wall 70B configuring a restriction section, and connecting the base section 66 to the lower end portion of the sloped wall 70B.

In the first and second exemplary embodiments, an example is given in which the mirror body 52 serving as a visual recognition means is provided to the door mirror device 10. However, an imaging means such as a camera, serving as a visual recognition means, may be provided to a vehicle visual recognition device. Moreover, an imaging means and the mirror body 52, each serving as a visual recognition means, may be provided to a vehicle visual recognition device.

The entire disclosure of Japanese Patent Application No. 2016-175543 is incorporated by reference in this specification.

All publications, patent applications, and technical standards mentioned in the present specification are incorporated by reference in the present specification to the same extent as if each individual publication, patent application, or technical standard was specifically and individually indicated to be incorporated by reference.

1-4. (canceled)

5. A vehicle visual recognition device, comprising:
a support section that is provided at a vehicle exterior section;
a main body that is supported by the support section, and that is provided with a visual recognition means to facilitate visual recognition by an occupant;
a seal member that is provided between the support section and the main body; and
a seal section that is provided at the seal member, that is elastically deformable, that effect sealing between the support section and the main body, and that is provided with a hollow portion at an extension portion extending from a base end side of the seal section in a radial direction relative to a direction of the main body rotation radial direction.

6. The vehicle visual recognition device of claim 5, further comprising a restriction section configured to restrict movement of the seal section in the radial direction.

7. The vehicle visual recognition device of claim 6, wherein:
the base end side of the extension portion of the seal section is restricted from moving in the radial direction; and
the extension portion of the seal section includes a first portion extending from one of the support section or the main body toward the other of the support section or the main body, and a second portion that is coupled to the first portion, that extends outward in the radial direction from the other of the support section or the main body toward the one of the support section or the main body such that the hollow portion is provided between the first portion and the second portion, and that is restricted from moving outward in the radial direction.

8. The vehicle visual recognition device of claim 7, wherein a leading end portion of the second portion is restricted from moving inward in the main body rotation radial direction.

9. A vehicle visual recognition device, comprising:
a support section that is provided at a vehicle exterior section;
a main body that is supported by the support section, and that is provided with a visual recognition means to facilitate visual recognition by an occupant;
a seal member that is provided between the support section and the main body;
a seal section that is provided at the seal member, that is elastically deformable, and that seals between the support section and the main body, with a hollow portion being provided at an extension portion extending from a base end side of the seal section in a radial direction relative to a direction of the main body rotation radial direction; and
a restriction section configured to restrict movement of the seal section in the radial direction,
the base end side of the extension portion of the seal section being restricted from moving in the radial direction, and
the extension portion of the seal section including a first portion that has a base end side restricted from moving in the radial direction, and that extends from one of the support section or the main body toward the other of the support section or the main body, and a second portion that is coupled to the first portion, that extends in the radial direction from the other of the support section or the main body toward the one of the support section or the main body such that the hollow portion is provided between the first portion and the second portion, and that is restricted from moving in the radial direction.

10. The vehicle visual recognition device of claim 1, wherein a leading end portion of the second portion is restricted from moving inward in the radial direction.
